(19) United States
(12) Patent Application Publication
(10) Pub. No.: US 2025/0250167 A1
(43) Pub. Date: Aug. 7, 2025

(54) PROCESS FOR PURIFYING A LITHIUM SALT OF BIS(FLUOROSULFONYL)IMIDE

(71) Applicant: SPECIALTY OPERATIONS FRANCE, Lyon (FR)

(72) Inventors: Joo-Hee Kang, Saint-Fons (FR); Philippe Carvin, Saint-Fons (FR)

(73) Assignee: SPECIALTY OPERATIONS FRANCE, Lyon (FR)

(21) Appl. No.: 18/855,234

(22) PCT Filed: Apr. 12, 2023
(86) PCT No.: PCT/EP2023/059489

§ 371 Date: Oct. 8, 2024

(30) Foreign Application Priority Data
Apr. 21, 2022 (EP) 22305584.9

(51) Int. Cl. C01B 21/086; B01D 11/02; H01M 10/0568

(52) U.S. Cl. CPC C01B 21/086; B01D 11/0203; H01M 10/0568; C01P 2006/40; C01P 2006/80; H01M 2300/0025

(57) ABSTRACT

The present disclosure relates to a process for purifying a lithium salt of bis(fluorosulfonyl)imide (LiFSI), wherein the purified LiFSI is extracted from a crude LiFSI through supercritical fluid extraction. The present invention also relates to the purified LiFSI obtained therefrom, as well as the use of such LiFSI in an electrolyte for batteries.

### CROSS-REFERENCE TO RELATED APPLICATION

This application claims priority to earlier European Patent Application No 22305584.9 filed on 21 Apr. 2022, the whole content of this application being incorporated herein by reference for all purposes.

### TECHNICAL FIELD

The present invention relates to a process for purifying the lithium salt of bis(fluorosulfonyl)imide (LiFSI) through supercritical fluid extraction. The present invention also relates to the purified LiFSI obtained therefrom, as well as the use of such LiFSI in an electrolyte for batteries.

### BACKGROUND

Bis(fluorosulfonyl)imide and salts thereof, in particular the lithium salt of bis(fluorosulfonyl)imide (LiFSI), are useful compounds in a variety of technical fields, including in battery electrolytes. For these battery applications, the presence of impurities is an important issue.

To suppress the contamination of metal impurities, US 2013/0331609 (in the name of Nippon Soda Co., Ltd.) suggests a process for producing a fluorosulfonyl imide ammonium salt including reacting a chlorosulfonlyimide compound with a fluorinating agent of formula NH₄F(HF)ₚ, wherein p is 0 to 10. The obtained fluorosulfonyl imide ammonium salt may then be subjected to a cation exchange reaction to produce another fluorosulfonyl imide salt. This process is said to be industrially efficient and to provide no metal impurities.

Similarly, patent documents JP 2016124735 (in the name of Nippon Catalytic Chem Ltd.) and JP 2016145147 (in the name of Nippon Catalytic Chem Ltd.) disclose a method for producing a fluorosulfonyl imide compound comprising the reaction of a chlorosulfonyl imide compound with NH₄F(HF)ₚ, wherein p is 0 to 10. The fluorosulfonyl imide compound may be reacted with an alkali metal compound to produce an alkali metal salt of fluorosulfonyl imide.

EP 3381923 (in the name of CLS) discloses a method for producing lithium bis(fluorosulfonyl)imide, which consists in reacting bis(chlorosulfonyl)imide with a fluorinating reagent in a solvent, followed by treatment with an alkaline reagent, thereby producing ammonium bis(fluorosulfonyl)imide, and then reacting the ammonium bis(fluorosulfonyl)imide with a lithium base to produce lithium bis(fluorosulfonyl)imide.

WO 2016/093399 (in the name of Chun Bo. Ltd.) discloses a method for producing and purifying lithium salt of sulfonyl imide. This method consists in reacting chlorosulfonic acid and chlorosulfonyl isocyanate to prepare chlorosulfonyl imide, then reacting said chlorosulfonyl imide with a fluorinated ammonium to prepare a fluorosulfonyl imide ammonium salt, then reacting said fluorosulfonyl imide ammonium salt with a lithium compound to obtain the lithium sulfonyl imide salt, and finally purifying said lithium sulfonyl imide salt with the help of a specific solvent.

EP 2674395 (in the name of Nippon Soda Co., Ltd.) discloses a process for producing a fluorosulfonyl imide ammonium salt with maximum suppression of the contamination of metal impurities. This process consists in reacting a specific chlorosulfonyl imide ammonium salt with hydrogen fluoride. The fluorosulfonyl imide ammonium salt obtained therefrom is then reacted with an alkali metal compound to obtain a fluorosulfonylimide alkali metal salt.

WO 2020/099527 (in the name of Solvay SA) discloses a process for producing an alkali salt of bis(fluorosulfonyl)imide economically feasible at industrial scale and which provides a high-purity product. Said process consists in reacting bis(chlorosulfonyl)imide or salts thereof with ammonium fluoride to produce ammonium salt of bis(fluorosulfonyl)imide, crystallizing by adding at least one precipitation solvent and separating the ammonium salt of bis(fluorosulfonyl)imide and reacting the crystallized ammonium salt of bis(fluorosulfonyl)imide with an alkali salt to obtain alkali salt of bis(fluorosulfonyl)imide.

### SUMMARY OF THE INVENTION

Although several methods have been disclosed in the art aimed at purifying the salts used in the manufacturing of electrolytes for battery applications, the Applicant perceived that there is still the need of developing methods for purifying LiFSI salt.

Facing the above technical problem, the Applicant unexpectedly developed a process for the manufacture of LiFSI, which is simple to perform in terms of apparatus and reaction conditions and very friendly from an environmental perspective.

Also, the process of the present invention allows to obtain LiFSI in solid form with a very high yield and high purity, such that it can be then used in a battery electrolyte solution.

The advantageous process for preparing LiFSI according to the present invention is based on supercritical fluid extraction.

Thus, in a first object, the present invention relates to a process for purifying a lithium salt of bis(fluorosulfonyl)imide (LiFSI) which is economically feasible at industrial scale and which provides a high-purity product.

### DRAWINGS

FIG. 1 represents a scheme of the laboratory setup used in Example 1.

### DISCLOSURE OF THE INVENTION

In the present application:
the expression “comprised between . . . and . . . ” should be understood as including the limits;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

A first object of the present invention relates to a process for purifying a lithium salt of bis(fluorosulfonyl)imide (LiFSI), comprising the steps of:
a) providing a crude composition [crude LiFSI] comprising LiFSI and at least one other compound;
b) contacting said crude LiFSI with at least one supercritical fluid; and
c) recovering a composition comprising LiFSI and at least one other compound in an amount lower than the crude LiFSI.

The term “crude composition” (hereinafter referred to as “crude LiFSI”) hereby means that the composition comprises LiFSI molecules in admixture with at least one other compound, which is an undesired compound negatively affecting the properties of the LiFSI when used—for example—as electrolyte in battery applications. Such at least one other compound can be referred to as an “impurity”. Said impurity comprises for example ions, solvent(s), water and/or reaction by-products. For example, the crude LiFSI may comprise from 80 to 99 wt. % of LiFSI, preferably 85-98 wt. %, more preferably 90-97 wt. % by weight, the rest being impurities to be removed through the process of the present invention.

Advantageously, in the process of the present invention, the crude LiFSI can be in the form of a solid, such as powder, or of a slurry or of a liquid, such as a solution.

The term “contacting” hereby means that the crude LiFSI is put in contact with the at least one supercritical fluid. For example, such contacting takes place in a vessel, under specific conditions of pressure and temperature, for a period of time sufficient for the fluid to remove at least part of the impurities present in the crude LiFSI, preferably more than 80.00%, more than 90.00%, more than 95.00%, more than 99.00%, more than 99.50% or even more than 99.90%. More preferentially, all the impurities are removed and the salt presents a purity above 99.95%, or even above 99.99%.

The term “recovering” hereby means that the purified LiFSI, preferably in solid form, is removed or extracted from the vessel in which step b) is carried out.

The expression “supercritical fluid” hereby means a gas (or a mixture of at least two gasses) in its supercritical state. Depending on the gas employed in step b), the pressures and temperatures to be used in the vessel in which the contact between the solution and the supercritical fluid takes place are properly selected. More precisely, in order to be in a supercritical state, the gas employed in step b) is held at or above its critical temperature and critical pressure.

According to the process of the present invention, at least one supercritical fluid is used to extract a purified LiFSI salt from the crude LiFSI, with several advantages. Supercritical fluids, such as sCO₂, offer many advantages, as they are usually easily available, inexpensive, non-toxic, non-explosive, and not organic solvents. Additionally, the process of the present invention operates at a moderate temperature (below 100° C.), which ensures a gentle treatment of the LiFSI product.

Preferably, step a) is carried out in batch, semi-continuously or continuously.

Preferably, said at least one other compound present in the crude LiFSI is selected from the group comprising, more preferably consisting of: water (H₂O), fluoride (F⁻), chloride (Cl⁻), sulfate (SO₄²⁻), sulfamate (NH₂SO₃⁻) and flurosulfonate (FSO₃⁻).

For example, the crude LiFSI to be purified may contain at least one of the following impurities: NH₄Cl, NH₄F, NH₄HF₂, NH₄FSO₃, NH₄SO₃NH₂, NH₄[N(SO₃H)(SO₂F)] (OFSI), and/or NH₄[N(SO₃H)₂] (OSI).

It will be clear to those skilled in the art that the parameters of the process according to the present invention can be properly selected and optimized based for example on the starting material (in particular, on the amount of the other compound(s) in the crude LiFSI) and on the scale at which the process is performed, for example is the process is performed at industrial scale or at laboratory scale.

Preferably, step b) is carried out at a pressure P of at least 80 bars.

Preferably, step b) is carried out at a temperature T between 30° C. and 90° C.

A particular advantage of the process of the present invention is that the contacting time under step b) is short. Also, advantageously, the contacting time under step b) can be properly selected for example on the basis of the starting material and the desired yield.

Preferably, the contacting time under step b) varies between a few seconds, for example 5 seconds, and 24 hours. More preferably, the contacting time under step d) varies between 1 minute and 12 hours, for example between 5 minutes and 10 hours or between 10 minutes and 5 hours.

In step b), the crude LiFSI is contacted with at least one supercritical fluid.

Preferably, step b) takes place in a vessel.

The term “vessel” hereby means a container well suited for the process of the present invention, that-is-to-say adapted to withstand the pressures and temperatures used in the process of the present invention, as well as to the possible corrosive character of the reactants and products involved in this process. The vessel used herein may also be called an extraction vessel or an extraction device. Also, the vessel used herein can be an extraction column (also referred to as “column”) or an autoclave.

According to a preferred embodiment, step b) consists in contacting the crude LiFSI of step a) with at least one supercritical fluid in a vessel.

Preferably, under step b), the crude LiFSI is contacted with one fluid in a supercritical state.

Preferably, under step b), the crude LiFSI is contacted with two or more fluids in a supercritical state. Said two or more fluids may be mixed or may be contacted with the crude LiFSI sequentially. As an example, the crude LiFSI may be contacted with a mixture of at least two supercritical fluids.

Additionally, according to the present invention, at least one other component, also called herein modifier, may be mixed to the supercritical fluid(s).

Advantageously, said at least one other component is selected from polar solvents having a solubility in the supercritical fluid below 10 wt. % based on the total weight of the supercritical fluids and the other component(s).

More preferably, when used, said at least one other component is in an amount ranging from 0.1 to 10 wt. %, for example from 0.5 to 8 wt. % or from 1 to 6 wt. %, based on the total weight of the supercritical fluids and the other component(s).

Preferably, said at least one other component is selected from polar solvents, more preferably, in the group comprising: alcohol, toluene, dimethyl sulfoxide (DMSO), acetonitrile, and the like. According to a preferred embodiment, said polar solvent is alcohol. Even more preferably, said alcohol is ethanol.

According to the present invention, step b) may be repeated one or several times.

For example, the process according to the present invention comprises a first step b) and a second step b′), wherein the same or different supercritical fluid(s), or a mixture of at least two supercritical fluids, are used in each of said step b) and said step b′).

In some embodiments, the vessel which is preferably used to contact the crude LiFSI with the at least one supercritical fluid under step b) is at a pressure P of at least 73 bars (7.3 MPa) during the extraction.

In some embodiments, the vessel which is preferably used to contact the crude LiFSI with the at least one supercritical fluid under step b) is at a temperature T between 30° C. and 90° C. during the extraction.

Preferably, the temperature T in the vessel may vary between 37° C. and 75° C., for example between 38° C. and 70° C. or between 40° C. and 65° C.

Preferably, the pressure P in the vessel may be at least 80 bars (8.0 MPa), at least 100 bars (10.0 MPa), at least 130 bars (13.0 MPa) or at least 150 bars (15.0 MPa). A very high pressure can be used in the process of the present invention, for example, the pressure P in the vessel may be up to 200 bars (20.0 MPa) or 300 bars (30.0 MPa). The pressure in the vessel will usually be less than 500 bars (50.0 MPa), for example less than 450 bars (45.0 MPa), less than 400 bars (40.0 MPa), or even less than 350 bars (35.0 MPa).

According to an embodiment, step b) is carried out by injection of the crude LiFSI in the vessel, which is already pressurized.

According to an embodiment, said crude LiFSI is in a solid form, such as in the form of powder.

According to another embodiment, said crude LiFSI is in a liquid form, such as a solution comprising LiFSI and an organic aprotic solvent.

Preferably, said organic aprotic solvent is selected in the group comprising ethylene carbonate, propylene carbonate, butylene carbonate, γ-butyrolactone, γ-valerolactone, dimethoxymethane, 1,2-dimethoxyethane, tetrahydrofuran, 2-methyltetrahydrofuran, 1,3-dioxane, 4-methyl-1,3-dioxolane, methyl formate, methyl acetate, methyl propionate, dimethyl carbonate, ethyl methyl carbonate, diethyl carbonate, sulfolane, 3-methylsulfolane, dimethylsulfoxide, N,N-dimethylformamide, N-methyl oxazolidinone, acetonitrile, valeronitrile, benzonitrile, ethyl acetate, isopropyl acetate, n-butyl acetate, nitromethane and nitrobenzene. More preferably, said solvent is selected from ethylene carbonate, propylene carbonate, butylene carbonate, tetrahydrofuran, dimethyl carbonate, ethyl methyl carbonate, diethyl carbonate, ethyl acetate, isopropyl acetate and n-butyl acetate. Even more preferably, said solvent is selected from dimethyl carbonate, ethyl methyl carbonate, diethyl carbonate, ethyl acetate, isopropyl acetate and n-butyl acetate. Still more preferably, said solvent is selected from ethyl methyl carbonate and n-butyl acetate.

The crude LiFSI may for example be injected in the vessel through an injector or an entry valve which is mounted on the vessel.

According to another embodiment, step b) comprises:
b1) introducing the crude LiFSI in the vessel;
b2) pressurizing the vessel to a pressure P;
b3) heating the vessel to a temperature T;
b4) introducing the at least one supercritical fluid in the vessel.

Preferably, step b2) may be performed before step b3), or step b3) may be performed before step b2), or step b2) and b3) may be performed concomitantly.

Preferably, the sequence of the steps might be as follows: b1), b3), b4) and b2).

The conditions of temperature, pressure and contacting time detailed above with regard to step b), apply to step b2) and b3) as described above.

Preferably, step b2) is performed at a pressure of at least 74 bars (7.4 MPa).

Preferably, step b3) is performed at a temperature of at least 30° C.

The flow rate for introducing the supercritical fluid in the vessel under step b4) is not particularly limited. The person skilled in the art can determine it based on the apparatus used and the amount and purity of the crude LiFSi.

Step b4) can be performed in batch, continuously or semi-continuously.

Preferably, the supercritical fluid used in step b) comprises supercritical carbon dioxide (sCO₂). sCO₂ is a fluid state of carbon dioxide that is held at or above its critical temperature (31.0° C.) and critical pressure (7.3773 MPa).

Advantageously, the supercritical fluid used in step b) may consist essentially in sCO₂, or it may consist in sCO₂.

According to an embodiment, the sCO₂ is mixed with up to 10 wt. % of ethanol, for example with 0.1 to 8 wt. % of ethanol, the wt. % being based on the total weight of the supercritical fluid and the ethanol.

The weight ratio of the supercritical fluid to the crude LiFSI used in the process of the present invention may vary between 1/1 and 400/1. For example, the weight ratio of the supercritical fluid to the crude LiFSI preferably varies between 5/1 and 350/1, for example between 20/1 and 300/1, between 30/1 and 280/1 or between 40/1 and 250/1.

The process of the present invention may be carried out in a batch mode, in a continuous or semi-continuous mode.

Preferably, the process is carried out in a continuous or semi-continuous manner.

Preferably, the process of the present invention comprises a step of continuously or semi-continuously withdrawing the purified salt of LiFSI from the vessel.

Preferably, according to the present invention, the injection of the crude LiFSI in the vessel is performed in a continuous or semi-continuous manner. In other words, according to an embodiment, the crude LiFSI is continuously injected in the vessel or alternatively the crude LiFSI is semi-continuously injected in the vessel. For example, the crude LiFSI may be injected in the vessel for a certain time (as an example between 30 and 120 sec, for example 60 sec) and then the injection is stopped for another period of time, which can be equal to, shorter or longer than the injection time.

For example, according to the present invention, the supercritical fluid can be introduced in the vessel in a continuous or semi-continous manner.

For example, the process of the present invention may comprise a step of continuously or semi-continuously withdrawing the salt of LiFSI from the vessel.

The purified LiFSI, which is recovered in step c), is preferably in solid form. The purified LiFSI is preferably recovered in the solid form, regardless if the starting crude LiFSI is in solid form, in the form of a slurry or a liquid. Even more preferably, said purified LiFSI is in the form of a powder.

Under step c), the LiFSi in solid form can be recovered once step b) is finished or while step b) is proceeding.

According to a specific embodiment of step c), the purified LiFSI flows into a separator with the supercritical fluid. The pressure is released and the supercritical fluid becomes a gas. Such gas is preferably recycled, as detailed below.

The process of the present invention may further comprise additional steps, such as preferably at least one step consisting in recycling the supercritical fluid.

For example, the supercritical fluid may be re-injected in the process of the present invention as such or after additional step(s) of purification.

The recycling of the supercritical fluid may be performed in several ways.

According to an embodiment, the supercritical fluid may be recycled in a continuous way during the process. Preferably, it is recycled using a supercritical fluid pipe under pressure.

According to another embodiment, the supercritical fluid may be recovered as a liquid phase by releasing the pressure in the vessel, and then re-pressurizing it in its gas form, for example by means of a compressor, in order to recycle it as a supercritical fluid which can be rejected in the vessel.

The process of the present invention may be carried out in an equipment comprising:
a vessel, which withstands the pressure and temperature used, for example a pressure P of at least 73 bars (7.3 MPa) and a temperature P above 30° C.;
a solvent trap;
a gas tank and a supercritical gas generator;
at least one injector/entry valve mounted on the vessel; and
optionally a separator.

The vessel may preferably be made of sapphire, SS316L, glass or graphite filled PTFE.

The equipment may include a separator. Different separators may be used in the process of the present invention. In some embodiments, the separation may be carried out through traditional filtration (also referred to as “dead end filtration”) or cross filtration, which is also called tangential filtration, as disclosed for example in US 2007/0021570 (in the name of Solvay SA.). Alternatively, cyclonic separators may be used, for example those which operate as gas/solid separators. The cyclonic separators are advantageous as allow recovering the solids, which could plug the filter media. Several hybrid devices exist based on this principle. Reference can notably be made to U.S. Pat. No. 7,410,620 (in the name of North Carolina State University).

Preferably, the solid LiFSI is recovered at the end of the process via a frit filter.

For example, said frit filter can be made of stainless steel. Preferably, said frit filter has at least one of the following characteristics:
pore size between 1 and 6 μm, preferably from 2 to 4 μm;
diameter between 1 and 20 mm, preferably between 5 and 15 mm, more preferably about 10 mm; and/or
thickness from 0.1 to 5 mm, preferably between 0.7 and 3.5 mm, more preferably between 1.5 and 2.5 mm.

If the equipment comprises a filter, or several filters, the filter(s) may notably be positioned at the bottom or at the top of the vessel.

A second object of the present invention is the lithium salt of bis(fluorosulfonyl)imide (LiFSI) in solid form obtainable by the process according to the present invention.

Advantageously, such LiFSI salt is characterized in that it contains LiFSI and:
fluoride (F⁻), preferably in an amount less than 100 ppm, as measured by lonic Chromatography (IC); and/or
chloride (Cl⁻), preferably in an amount less than 100 ppm, as measured by IC; and/or
sulfate (SO₄²⁻), preferably in an amount less than 1,000 ppm, as measured by IC; and/or
sulfamate (NH₂SO₃⁻), preferably in an amount less than 1,000 ppm, as measured by IC; and/or
fluorosulfonate (FSO₃⁻), preferably in an amount less than 1,000 ppm, as measured by IC; and/or
water, preferably in an amount less than 50 ppm, as measured by the KF analysis (oven method).

It is indeed an object of the present invention to provide a LiFSI salt with very low amounts of impurities. As detailed below in the experimental part, the inventors have been able to achieve a high level of purity of the LiFSI salt, above 99.90%, starting from a crude product having a purity of 98.00%. The LiFSI salt of the present invention preferably has a purity of more than 99.50%, more than 99.60%, more than 99.70%, more than 99.80%, more than 99.90% and even more than 99.95%, as measured by Li-NMR.

The amounts of the impurities in the LiFSI product recovered at the end of the process according to the present invention are preferably selected from:
fluoride (F⁻), in an amount up to 50 ppm, for example less than 40 ppm, less than 30 ppm, less than 25 ppm as measured by lonic Chromatography (IC); and/or
chloride (Cl⁻), in an amount up to 50 ppm, for example less than 40 ppm, less than 30 ppm, less than 20 ppm, less than 10 ppm or even less than 8 ppm as measured by IC; and/or
acid substances different from sulfate (SO₄²⁻), in an amount up to 100 ppm, for example less than 50 ppm, less than 30 ppm, less than 10 ppm, less than 5 ppm as measured by IC; and/or
water, in an amount up to 50 ppm, as measured by the KF analysis (oven method).

Preferably, said acid substances different from sulfate (SO₄²⁻) are selected from NH₂SO₃⁻ and/or FSO₃⁻.

Preferably, said acid substances different from sulfate (SO₄²⁻) are in the following amounts:
less than 50 ppm of sulfamate (NH₂SO₃⁻), for example less than 40 ppm, less than 30 ppm, less than 20 ppm, less than 10 ppm or even less than 5 ppm as measured by IC; and/or
less than 50 ppm of fluorosulfonate (FSO₃⁻), for example less than 40 ppm, less than 30 ppm, less than 20 ppm, less than 10 ppm or even less than 5 ppm as measured by IC.

The LiFSI salts of the present invention also preferably comprises at least one of the following chemical entities (as measured by Ion Chromatography):
iron (Fe), in an amount below 1,000 ppm, preferably below 500 ppm, more preferably below 100 ppm;
chromium (Cr), in an amount below 1,000 ppm, preferably below 500 ppm, more preferably below 100 ppm;
nickel (Ni), in an amount below 1,000 ppm, preferably below 500 ppm, more preferably below 100 ppm;
zinc (Zn), in an amount below 1,000 ppm, preferably below 100 ppm, more preferably below 10 ppm;
copper (Cu), in an amount below 1,000 ppm, preferably below 100 ppm, more preferably below 10 ppm;
bismuth (Bi), in an amount below 1,000 ppm, preferably below 100 ppm, more preferably below 10 ppm;
sodium (Na⁺), in an amount below 10,000 ppm, preferably below 5 000 ppm, more preferably below 500 ppm or even below 100 ppm; and/or
potassium (K⁺), in an amount below 10,000 ppm, preferably below 5 000 ppm, more preferably below 500 ppm or even below 100 ppm.

The purified LiFSI salt of the present invention is characterized in that it contains less than 50 ppm of water, as measured by the KF analysis (oven method). Preferably, the purified LiFSI salt comprises less than 40 ppm, less than 30 ppm, less than 20 ppm, less than 10 ppm or even less than 5 ppm of water.

A third object of the present invention relates to a solid comprising lithium salt of bis(fluorosulfonyl)imide (LiFSI) and at least one other substance, said at least one other substance being selected from:
water, in an amount preferably less than 50 ppm, as measured by the KF analysis via an oven method; and/or
fluoride (F⁻), in an amount preferably less than 25 ppm; and/or
chloride (Cl⁻), in an amount preferably less than 8 ppm; and/or
sulfate (SO₄²⁻), in an amount preferably less than 20 ppm; and/or
acid substances different from sulfate (SO₄²⁻), in an amount preferably less than 1 ppm.

Preferably, said acid substances are selected from NH₂SO₃⁻ and/or FSO₃⁻.

A fourth object of the present invention relates to the use of lithium salt of bis(fluorosulfonyl)imide (LiFSI) in the solid form according to the present invention, in a battery electrolyte solution.

A fifth object of the present invention is the use of supercritical fluid extraction for purifying a crude lithium salt of bis(fluorosulfonyl)imide (LiFSI) comprising the LiFSI and impurities.

Should the disclosure of any patents, patent applications, and publications which are incorporated herein by reference conflict with the description of the present application to the extent that it may render a term unclear, the present description shall take precedence.

The present invention will be now described in more detail with reference to the following examples, whose purpose is merely illustrative and not intended to limit the scope of the disclosure.

### EXAMPLES

### Materials

Crude LiFSI, purchased from Provisco, with the following characterization:
water <10 ppm, as determined by the KF analysis (oven method) described below in more details
F⁻=1420 ppm, as determined by IC*
Cl⁻<5 ppm, as determined by IC*
SO₄²⁻=11,000 ppm, as determined by IC*
NH₂SO₃⁻=1,190 ppm, as determined by IC*
FSO₃⁻=7,210 ppm, as determined by IC*
Purity=98%, as determined by Li-NMR
*IC: Ion Chromatography (DIONEX ICS-3000)

According to the KF analysis (oven method), the sample was prepared by a fully automated oven sample processor (Metrohm); sample weight as 0.1 g, carrier gas=N₂, oven temperature=160° C. The titration was performed using a mixture of methanol and NH₄F (1:1 v/v). The polarization stream for potentiometric determination of reaction endpoint was 10 μA and titration endpoint voltage was 50 mV.

### Example 1—Preparation of High Purity LiFSI in Powder Form Starting from Crude LiFSI

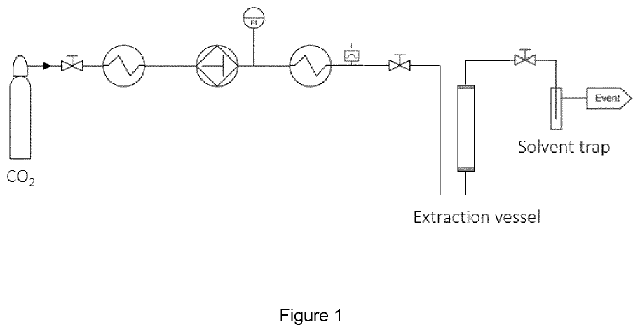

The equipment setup of FIG. 1 was used and the experiment was performed with the following procedure.

4.524 g of crude LiFSI was introduced into a vessel. The vessel was pressurized with sCO₂ (Temperature 45° C.; Pressure 200 bars; CO₂/LiFSI solution ratio varying between 30 and 400 along the process). The exit valve was then opened at the desired level to set the flow rate of CO₂ (165 g/min). After a contacting time in the vessel of about 10h, the entry valve, between the buffer tank and the vessel, was closed so that the vessel and the exit line were depressurized.

The following were obtained.

A mass loss of 0.12 g (2.65 wt. %) was observed after 10 h of extraction. A plateau was observed at CO₂/crude LiFSI mass ratio=180, corresponding to 5 h of extraction.

The extracted powder flowed easily off the vessel with gravity. In comparison, the crude LiFSI was sticky on the vessel surface.

The water content in a sample of the LiFSI solid product was lower than 50 ppm, as measured according to the KF analysis (oven method).

No main impurities were detected by Ion Chromatography (DIONEX ICS-3000):
F⁻<20 ppm
Cl⁻<5 ppm
SO₄²⁻<15 ppm
NH₂SO³⁻ n/d (not detected)
FSO₃⁻ n/d (not detected)

A purity of more than 99.9% was determined by Li-NMR.

1. A process for purifying a lithium salt of bis(fluorosulfonyl)imide (LiFSI), comprising the steps of:
a) providing a crude composition [crude LiFSI] comprising LiFSI and at least one other compound;
b) contacting said crude LiFSI with at least one supercritical fluid; and
c) recovering a composition comprising purified LiFSI and at least one other compound in an amount lower than the crude LiFSI.

2. The process according to claim 1, wherein said at least one supercritical fluid in step b) is selected from: one fluid in a supercritical state, or a mixture of at least two fluids in supercritical state.

3. The process according to claim 1, wherein
said crude LiFSI is in the form of a solid, a slurry or a solution; and/or
the purified LiFSI is in the form of a solid.

4. The process according to claim 1, wherein step b) is carried out in a vessel at a pressure P of at least 73 bars (7.3 MPa) and/or a temperature T between 30° C. and 90° C.

5. The process according to claim 1, wherein said supercritical fluid(s) comprises CO₂, optionally in admixture with at least one polar solvent having a solubility in the supercritical fluid below 10 wt. % based on a total weight of said supercritical fluid and said at least one polar solvent.

6. The process according to claim 4, wherein:
the pressure P in the vessel ranges between 80 bars (8.0 MPa) and 500 bars (50.0 MPa); and/or
the temperature in the vessel ranges between 35° C. and 80° C.

7. The process according to claim 1, wherein the process is carried out continuously or semi-continuously.

8. The process according to claim 1, wherein said at least one other compound in the crude LiFSI is selected from the group comprising: water (H₂O), fluoride (F⁻), sulfate (SO₄²⁻), chloride (Cl⁻), sulfamate (NH₂SO₃⁻) and fluorosulfonate (FSO₃⁻).

9. The process according to claim 1, further comprising at least one step of recycling the supercritical fluid.

10. The process according to claim 1, said process being carried out in an equipment comprising:
a vessel, which can withstand a pressure P of at least 80 bars and a temperature T above 10° C.;
a solvent trap;
a gas tank and a supercritical gas generator;
at least one injector/entry valve mounted on the vessel; and
optionally a separator.

11. The lithium salt of bis(fluorosulfonyl)imide (LiFSI) in solid form obtained by the process according to claim 1, characterized in that said salt contains LiFSI and:
fluoride (F⁻) in an amount less than 100 ppm, as measured by Ionic Chromatography (IC); and/or
chloride (Cl⁻) in an amount less than 100 ppm, as measured by IC; and/or
sulfate (SO₄²⁻) in an amount less than 1,000 ppm, as measured by IC; and/or
sulfamate (NH₂SO₃⁻) in an amount less than 1,000 ppm, as measured by IC; and/or
fluorosulfonate (FSO₃⁻) in an amount less than 1,000 ppm, as measured by IC; and/or
water in an amount less than 50 ppm, as measured by KF analysis (oven method).

12. A solid comprising lithium salt of bis(fluorosulfonyl)imide (LiFSI) and at least one other substance, said at least one other substance being selected from:
water, in an amount less than 50 ppm, as measured by KF analysis via an oven method; and/or
fluoride (F⁻), in an amount less than 25 ppm; and/or
chloride (Cl⁻), in an amount less than 8 ppm; and/or
sulfate (SO₄²⁻), in an amount less than 20 ppm; and/or
acid substances different from sulfate (SO₄²⁻) in an amount less than 1 ppm.

13. A battery electrolyte solution formed with the lithium salt of bis(fluorosulfonyl)imide (LiFSI) according to claim 11.

14. The process of claim 1, wherein during step b) is the crude composition of lithium bis(fluorosulfonyl)imide (crude LiFSI) comprising LiFSI and at least one impurity is purified by a supercritical fluid extraction.

15. The process according to claim 1, wherein said at least one other compound in the crude LiFSI is selected from the group consisting of: water (H₂O), fluoride (F⁻), sulfate (SO₄²⁻), chloride (Cl⁻), sulfamate (NH₂SO₃⁻) and fluorosulfonate (FSO₃⁻).

16. A battery electrolyte solution formed with the solid according to claim 12.
